(19) United States
(12) Patent Application Publication
(10) Pub. No.: US 2013/0047908 A1
(43) Pub. Date: Feb. 28, 2013

(54) MARINE TURBINE LIFT

(71) Applicants: Robert Allen Baten, Baytown, TX (US); Edward John Halusic, III, Albany, NY (US); Doyle Jackson Marrs, JR., Crestview, FL (US)

(72) Inventors: Robert Allen Baten, Baytown, TX (US); Edward John Halusic, III, Albany, NY (US); Doyle Jackson Marrs, JR., Crestview, FL (US)

(73) Assignee: General Electric Company, Schenectady, NY (US)

(21) Appl. No.: 13/220,614

(22) Filed: Aug. 29, 2011

(51) Int. Cl. B63B 27/16; B66C 23/52; B66C 23/16; B66C 23/06; B66C 1/44

(52) U.S. Cl. 114/268; 414/738; 414/741; 414/728

(57) ABSTRACT

A system includes a turbine lift. The turbine lift includes a mounting base configured to mount to a non-stable structure. The turbine lift also includes an arm coupled to the mounting base. The turbine lift further includes a stabilizing head coupled to the arm, wherein the stabilizing head is configured to connect with a turbine engine, and the stabilizing head is configured to stabilize the turbine engine while moving the turbine engine.

### BACKGROUND OF THE INVENTION

The subject matter disclosed herein relates to turbine engines, and more specifically, to a marine turbine lift for moving turbine engines.

Turbine engines (e.g., gas turbine engines) are commonly utilized in marine applications, such as watercraft and/or floating platforms (e.g., deep-sea platforms). Occasionally, these turbine engines need removal (e.g., for repair or replacement) or installation in order to regain propulsion and/or electrical power. Existing lifting systems employ land based lifts with chains or slings. Unfortunately, these land based lifts require docking of the watercraft and/or floating platform. Furthermore, the chains or slings do not enable complete control of the turbine engine in every degree of freedom between the engine and the stationary ground. For example, the lack of stability or rigidity in the chains or slings may result in undesirable tilting, swinging, rotation, or other uncontrolled movements, which can complicate the installations or removal of the turbine engine.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a turbine lift. The turbine lift includes a mounting base configured to mount to a non-stable structure. The turbine lift also includes an arm coupled to the mounting base. The turbine lift further includes a stabilizing head coupled to the arm, wherein the stabilizing head is configured to connect with a turbine engine, and the stabilizing head is configured to stabilize the turbine engine while moving the turbine engine.

In accordance with a second embodiment, a system includes a turbine lift. The turbine lift includes a mounting base, an arm coupled to the mounting base, and a stabilizing head coupled to the arm. The stabilizing head is configured to connect with a turbine engine, the stabilizing head includes a drive assembly coupled to a joint assembly, and the joint assembly includes at least one axis of rotation.

In accordance with a third embodiment, a system includes a turbine lift. The turbine lift includes a mounting base, an arm coupled to the mounting base, and a stabilizing head including a spreader bar configured to support a turbine engine. The spreader bar includes a first rigid connection configured to rigidly connect the spreader bar to the turbine engine, or a second rigid connection configured to rigidly connect the spreader bar to the arm, or a combination thereof.

In accordance with a fourth embodiment, a system includes a turbine lift. The turbine lift includes a mounting base, an arm coupled to the mounting base, and a stabilizing head including a spreader bar configured to support a turbine engine. The spreader bar includes a main portion and one or more extension portions, and the stabilizing head is configured to connect the arm to the main portion of the spreader bar.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic side view of an embodiment of a watercraft having a turbine lift for lifting one or more turbine engines;

FIG. 2 is a schematic top view of an embodiment of the watercraft having the turbine lift for lifting the one or more turbine engines;

FIG. 3 is a perspective view of an embodiment of the turbine lift of FIGS. 1 and 2;

FIG. 4 is a schematic view of an embodiment of a stabilizing head of a turbine lift having a spreader bar with a main portion connected to a turbine;

FIG. 5 is a schematic view of an embodiment of a stabilizing head of a turbine lift having a spreader bar with both a main portion and an extension connected to a turbine;

FIG. 6 is a schematic view of an embodiment of a stabilizing head of a turbine lift having a spreader bar with both a main portion and an extension connected to a gas turbine and a power turbine;

FIG. 7 is a close-up perspective view of an embodiment of a stabilizing head of the turbine lift of FIG. 3;

FIG. 8 is a partial cutaway perspective view of an embodiment of the stabilizing head of FIG. 7, taken along line 8-8 of FIG. 7;

FIG. 9 is a partial cutaway perspective of an embodiment of the stabilizing head of FIG. 7, taken along line 9-9 of FIG. 7;

FIG. 10 is a schematic side view of an embodiment of a movable base system for moving the turbine lift of FIGS. 1 and 2; and

FIG. 11 is a perspective view of an embodiment of a main portion of a spreader bar.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed to systems for maneuvering a turbine engine on land or at sea, particularly in marine applications during rough seas, with a stabilizing system to enable complete control of the turbine engine during the lifting process (e.g., installation/removal). Embodiments of the present disclosure provide a system that includes a turbine lift (e.g., marine turbine lift) designed to mount and operate on a non-stable structure (e.g., watercraft), such that the turbine engine may be removed and installed away from land (e.g., dock). The marine turbine lift includes a mounting base configured to mount to a watercraft, an arm coupled to the mounting base, and a stabilizing head coupled to the arm. The mounting base may include sliding and rotating portions that respectively enable movement of the marine turbine lift along a deck of the watercraft, and also enable rotation of the arm about an axis crosswise to the deck. The stabilizing head is configured to connect to the turbine engine (e.g., gas turbine and/or power turbine) and to stabilize the turbine engine while moving the engine. For example, the stabilizing head may include a spreader bar to rigidly connect with the turbine engine, rather than loosely or flexibly connect with a sling or chains. The spreader bar may include a main portion that connects to the stabilizing head at a connection along a length of the main portion and/or one or more extension portions. The extension portion may be used to accommodate turbine systems of different lengths and/or to help balance the weight of the turbine system relative to the connection between the spreader bar and the stabilizing head. The stabilizing head may include one or more joint assemblies, each coupled to a drive and operable to rotate about a different axis of rotation. In addition, the arm of the marine turbine lift may include arm portions coupled via a movable joint that enables movement of the turbine engine in a vertical direction. The marine turbine lift is designed to enable complete control of the turbine engine in every degree of freedom between the turbine engine and stationary ground (e.g., deck). In other words, the marine turbine lift substantially reduces or eliminates uncontrolled movement of the turbine engine by stabilizing the connection between the deck of the watercraft and the turbine engine while also enabling powered rotation about multiple axes.

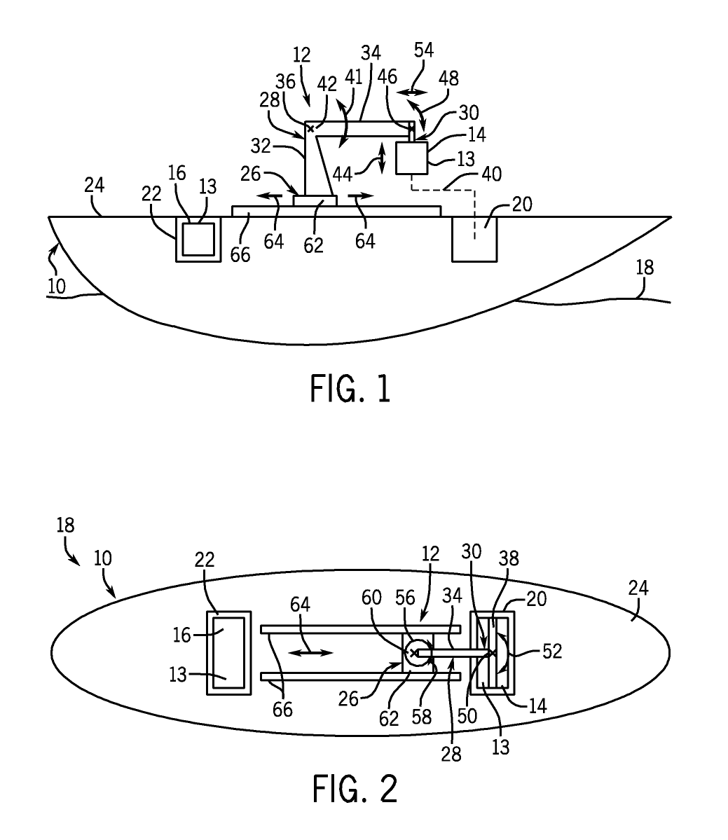

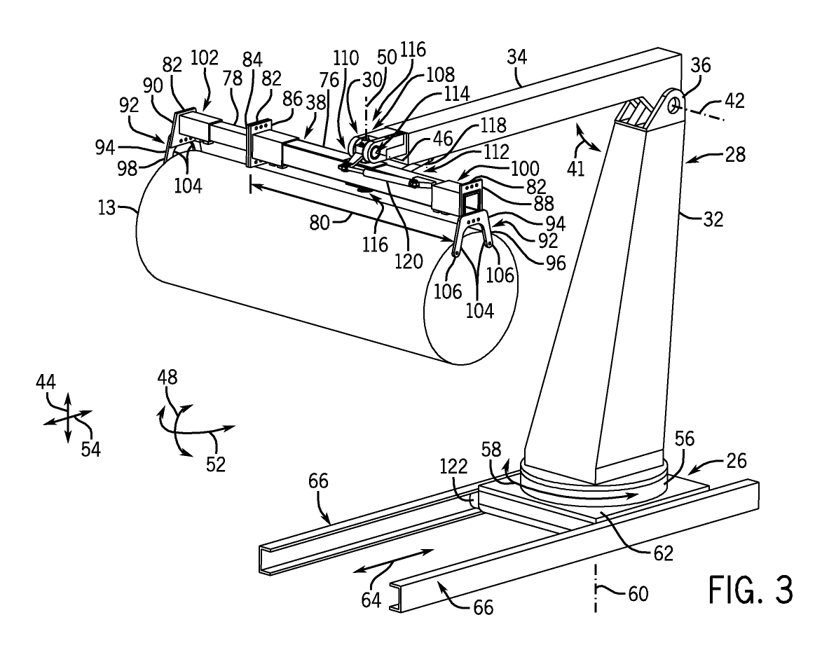

FIGS. 1 and 2 are schematic side and top views, respectively, of an embodiment of a watercraft 10 having a turbine lift 12 (e.g., marine turbine lift) for lifting one or more turbine engines 13 (e.g., 14 and 16). Although the following discusses the turbine lift 12 in the context of marine applications, the turbine lift 12 may be utilized in land-based applications in certain embodiments. Likewise, although the lift 12 is discussed in context of a turbine, the lift 12 may be used to lift a variety of bulky sensitive equipment, such as combustion engines, transmissions, generators, electronics, and the like. As discussed in greater detail below, the turbine lift 12 enables the complete control of the turbine engine 13 during lifting (e.g., installation and/or removal) in every degree of freedom between the turbine engine 13 and stationary ground (e.g., deck of watercraft 10 or land). The lifted turbine engine 13 may include a gas turbine engine, a power turbine engine, a steam turbine engine, or any other engine, or a combination thereof. As illustrated, the watercraft 10 (e.g., ship, boat, or platform) is located on a body of water 18 (e.g., lake, ocean, sea, river, or any other body of water). In certain embodiments, the body of water 18 may experience rough conditions (e.g., due to weather conditions or other causes) and lifting of the turbine engine 13 by the turbine lift 12 may occur during these rough conditions.

The watercraft 10 includes compartments 20 and 22 (e.g., turbine compartments) for turbine engines 14 and 16, respectively. The turbine lift 12 is disposed on the deck 24 between the compartments 20 and 22. In certain embodiments, the number of compartments 20 and 22 and turbine engines 13 may vary. The turbine lift 12 includes a rail system for movement of a mounting base 26, a mounting base 26 coupled to the deck 24 of the watercraft 10, an arm 28 coupled to the mounting base 26, and a stabilizing head 30 coupled to the arm 28.

The arm 28 includes a first arm portion 32 coupled to the mounting base 26 and a second arm portion 34 coupled to the first arm portion 32 at a moveable or rotatable joint 36. The second arm portion 34 is coupled to the stabilizing head 30. The stabilizing head 30 is configured to connect with and stabilize the turbine engine 13 during the installation and/or removal of the turbine engine 13. The stabilizing head 30 includes a spreader bar 38 (see FIG. 2) to connect to the turbine engine 13. As described in greater detail below, the spreader bar 38 may include one or more portions (e.g., main portion and extensions portions) to enable attachment to the turbine engine 13. The spreader bar 38 is configured to rigidly connect with the turbine engine 13. For example, the spreader bar 38 may include a first rigid connection configured to rigidly connect the spreader bar 38 to the turbine engine 14. In certain embodiments, the spreader bar 38 includes a second rigid connection configured to rigidly connect the spreader bar 38 to the arm 28 (i.e., second arm portion 34). Accordingly, the turbine lift 12 may be entirely free of loose, flexible connections, such as flexible sling or chains.

As illustrated, the turbine lift 12 is connected to the turbine engine 14. The turbine lift 12 may remove from compartment 20 and/or install into compartment 20 the turbine engine 14 as indicated by dashed line 40. As mentioned, the turbine lift 12 is configured to enable the complete control of the turbine engine 14 during lifting (e.g., installation and/or removal) in every degree of freedom between the turbine engine 14 and stationary ground. For example, the rotatable or moveable joint 36 of the arm 28 enables movement (e.g., rotation) 41 of the second arm portion 34 about an axis of rotation 42 to enable movement of the turbine engine 14 in a vertical direction 44 relative to the deck 24. In addition, the stabilizing head 30 enables movement of the turbine engine 14 about one or more axes of rotation (e.g., 1, 2, 3, or more axes of rotation). For example, the stabilizing head 30 may include a joint assembly that includes a first joint with a first axis of rotation 46 (e.g., horizontal axis of rotation parallel with the deck 24) to enable rotation of the joint assembly as indicated by arrow 48 in FIG. 1, and a second joint with a second axis of rotation 50 (e.g., vertical axis of rotation perpendicular to the deck 24) to enable rotation of the joint assembly as indicated by arrow 52 in FIG. 2. The axes of rotation 46 and 50 are crosswise (e.g., perpendicular) to one another. As described in greater detail below, the stabilizing head 30 may include a drive assembly coupled to the joint assembly that includes multiple drives (e.g., hydraulic or electric drives) to control rotation of the first and second joints about their respective axes of rotation 46 and 50. Rotation of the joint assembly about the first axis of rotation 46 via the drive assembly enables control of swing in movement 48 of the turbine engine 14 in both a horizontal direction 54 and the vertical direction 44 relative to the deck 24.

Besides movement via the movable joint 36 of the arm 28 and the stabilizing head 30, the mounting base 26 also enables movement of the turbine engine 14 connected to the turbine lift 12. For example, as shown in FIG. 2, the mounting base 26 includes a rotating portion 56 configured to rotate 58 the arm 28 about a vertical axis of rotation 60 crosswise to the deck 24 of the watercraft 10. The rotating portion 56 may have any suitable range of rotational movement, e.g., 180 degrees or more, about the axis 60. Accordingly, the rotating portion enables rotation of the arm 28 and, thus, the turbine engine 14 about the axis 60 sufficient to install and remove the turbine engines 13 from the compartments 20 and 22. In certain embodiments, the rotating portion 56 enables 360 degrees of movement or rotation about the axis 60. The mounting base 26 also includes a sliding portion 62 configured to move the arm 28 along the deck 24 of the watercraft 10 in direction 64 between the compartments 20 and 22. In certain embodiments, the sliding portion 62 enables movement along a rail structure 66. For example, in some embodiments, the sliding portion 62 includes wheels to enable movement along the rail structure 66. These components of the turbine lift 12 enable the lift 12 to completely control the movement of the turbine engine 14 relative to the deck 24 of the watercraft 10. In particular, the rigid connection between the turbine lift 12 and the turbine engine 14 minimizes the movement between the deck 24 and engine 14 during rough seas, thereby protecting the engine 14 and the watercraft 10 from potential damage as the engine 14 is lifted while subject to unpredictable motion of the sea.

FIG. 3 is a perspective view of an embodiment of the turbine lift 12 (e.g., marine turbine lift) of FIGS. 1 and 2. As mentioned above, the turbine lift 12 includes the mounting base 26, the arm coupled 28 to the mounting base 26, and the stabilizing head 30 coupled to the arm 28. The arm 28 includes the first arm portion 32 coupled to the mounting base 26 and the second arm portion 34 coupled to the movable joint 36. The movable joint 36 (e.g., rotational joint) enables movement 41 (e.g., rotation) of the second arm portion 34 and, thus, the turbine engine 13 about axis 42 as described above. The second arm portion 34 is coupled to the stabilizing head 30.

The stabilizing head 30 is configured to connect with and stabilize the turbine engine 13 during the installation and/or removal of the turbine engine 13. The stabilizing head 30 includes the spreader bar 38 connected to the turbine engine 13. As illustrated, the spreader bar 38 includes a main portion 76 and an extension portion 78 connected to the turbine engine 13. The main portion 76 includes a single bar or beam 79. The stabilizing head 30 connects the arm 28 (i.e., second arm portion 34) to the main portion 76 of the spreader bar 38 at a position along a length 80 of the main portion 76. In particular, the stabilizing head 30 connects at a position appropriate for lifting of the engine 13, for example, near the engine's center of gravity. In certain embodiments, the stabilizing head 30 connects the arm 28 to the main portion 76 of the spreader bar at a position approximately midway (e.g., 50 percent) along the length 80. In other embodiments, the stabilizing head 30 connects at a position offset from midway along the length 80. The extension portion 78 of the spreader bar 38 is coupled to the main portion 76 via flanges 82 (e.g., 84 and 86). The main portion 76 of the spreader bar 38 includes flanges 86 and 88, and the extension portion 78 includes flanges 84 and 90. In certain embodiments, the main and extension portions 76 and 78 may be connected via the insertion of one of the portions 76 or 78 into an end of the other portion 76 or 78 (e.g., a male-female connection), or some other type of connection. As illustrated, the spreader bar 38 includes the main portion 76 and the extension portion 78. In some embodiments, the spreader bar 38 may include more than one extension portion 78 (e.g., 2, 3, 4, 5, or more) attached to the main portion 76. In other embodiments, the spreader bar 38 may include only the main portion 76. The number of extension portions 78 used with the spreader bar 38 depends on factors related to the turbine engine 13. For example, the illustrated turbine engine 13 may include a gas turbine engine and/or power turbine engine aerodynamically-coupled to the gas turbine engine. The particular configuration of the turbine engine 13 (e.g., the gas turbine engine and/or the power turbine engine) affects the center of gravity of the lifted turbine engine 13 as described in greater detail below. The addition of the extension portions 38 accommodates for the center of gravity of the lifted turbine engine 13 to balance the weight relative to the arm 28 and head 30. Other factors to consider in the configuration of the spreader bar 38 include the length of the turbine engine 13. The spreader bar 38 is configured to rigidly connect with the turbine engine 13. For example, the spreader bar 38 may include a first rigid connection 92 (e.g., one two, or more rigid connections) configured to rigidly connect the spreader bar 38 to the turbine engine 13. The rigid connection 92 is formed between plates 94 (e.g., 96 and 98) attached to the flanges 82 at ends 100 and 102 of the spreader bar 38 and the turbine engine 13. As illustrated, the plate 96 is attached to the flange 88 at the end 100 of the main portion 76, and the plate 98 is attached to the flange 90 at the end 102 of the extension portion 78 of the spreader bar 38. Ends 104 of the plates 94 may be fastened to eyes located on the turbine engine 13 via pins 106. The illustrated plates 94 of the rigid connection 92 include a U-shape formed by the ends 104. In certain embodiments, the shape of plates 94 may include a V-shape, C-shape, W-shape, or any other type of shape. In addition, the spreader bar 38 includes a second rigid connection 108 configured to rigidly connect the spreader bar 38 to the arm 28 (i.e., second arm portion 34) as described in greater detail below.

The stabilizing head 30 of the turbine lift 12 includes a joint assembly 110 and a drive assembly 112 coupled to the joint assembly 110 to enable complete control of the turbine engine 13 during lifting (e.g., installation and/or removal) in every degree of freedom between the turbine engine 13 and stationary ground. The joint assembly 110 enables movement of the turbine engine 14 about multiple axes (e.g., 2, 3, or more) of rotation 46 and 50. For example, the joint assembly 110 includes a first joint 114 with the first axis of rotation 46 (e.g., horizontal axis of rotation) to enable rotation of the joint assembly 110 as indicated by arrow 48. The joint assembly 110 also includes a second joint 116 with the second axis of rotation 50 (e.g., vertical axis of rotation) to enable rotation of the joint assembly 110 as indicated by arrow 52. The axes of rotation 46 and 50 are crosswise (e.g., perpendicular) to one another. The drive assembly 112 is configured to control rotation of the joint assembly 110 about the axes 46 and 50. For example, the drive assembly 112 includes a first drive 118 (e.g., hydraulic, pneumatic, or electric drive) configured to control rotation of the first joint 114 about the first axis of rotation 46 (e.g., horizontal axis of rotation). The drive assembly 112 also includes a second drive 120 (e.g., hydraulic, pneumatic, or electric drive) configured to control rotation of the second joint 116 about the second axis of rotation 50 (e.g., vertical axis of rotation). The first and second drives 118 and 120 may include telescoping cylinders configured to extend and retract over a range of distances. Furthermore, the first and second drives 118 and 120 may be powered by a hydraulic system (e.g., hydraulic pump), a pneumatic system (e.g., compressed gas), an electric motor, or any combination thereof. Rotation of the joint assembly 110 about the first axis of rotation 46 via the drive assembly 112 enables control of swing in movement 48 of the turbine engine 14 in both the horizontal direction 54 and the vertical direction 44 relative to the stationary ground.

As mentioned above, the mounting base 26 is configured to enable additional movement of the turbine engine 13. The mounting base 26 is configured to mount to watercraft 10. In certain embodiments, the mounting base 26 is configured to be mounted for land-based applications. The mounting base 26 includes the rotating portion 56 configured to rotate 58 the arm 28 about the vertical axis of rotation 60 crosswise to the stationary ground. Rotation of the rotating portion 56 enables at least 180 degrees of movement or rotation of the arm 28 and, thus, the turbine engine 14 about the axis 60. In certain embodiments, the rotating portion 56 enables 360 degrees of movement or rotation about the axis 60. The mounting base 26 also includes the sliding portion 62 configured to move the arm 28 along the stationary ground in direction 64. In certain embodiments, the sliding portion 62 enables movement along the rail structure 66 (e.g., opposite rails). As illustrated, the sliding portion 62 includes wheels 122 (e.g., 1, 2, 3, 4, or more wheels per rail) to enable movement along the rail structure 66 as described in greater detail below. These components of the turbine lift 12 enable the lift 12 to completely control the movement of the turbine engine 13 relative to the stationary ground (e.g., deck 24 of the watercraft 10). In particular, the rigid connection 92 between the turbine lift 12 and the turbine engine 13 minimizes the movement between the lift 12 and engine 13 (e.g., during rough seas), thereby substantially reducing undesired or unexpected movement of the engine 13 as a result of unpredictable motion attributed to the sea.

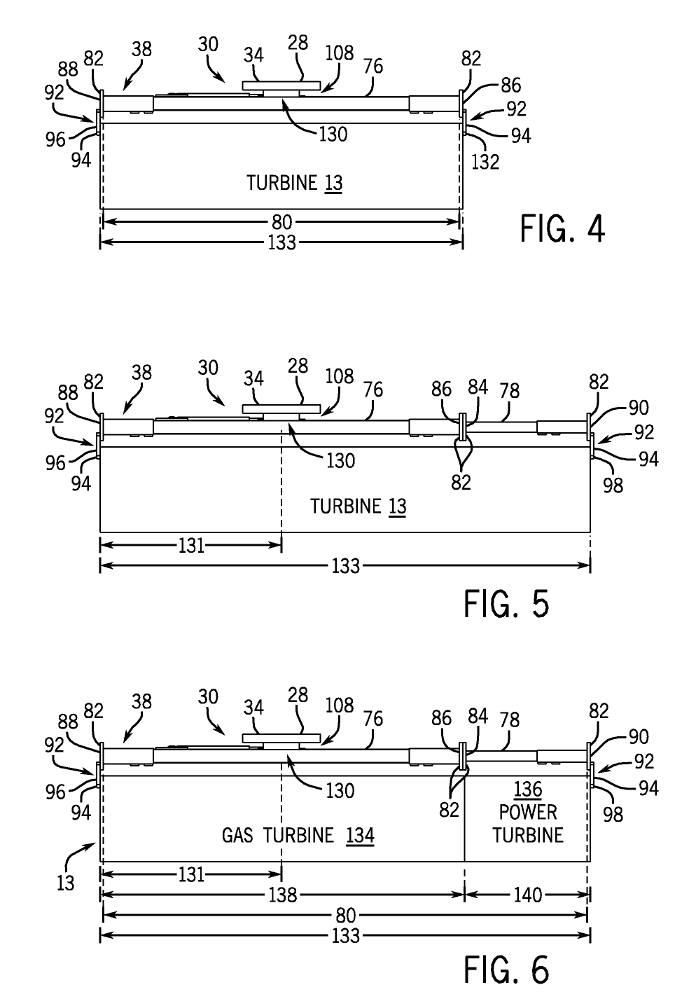

As mentioned above, the configuration of the spreader bar 38 may vary depending on factors related to the turbine engine 13. Such factors include the length of the turbine engine 13, the center of gravity of the turbine engine 13, and the configuration of the turbine engine 13 being lifted. For example, the turbine engine 13 may include a gas turbine engine and/or power turbine engine aerodynamically-coupled to the gas turbine engine. FIGS. 4-6 are schematic views of embodiments of different configurations of the spreader bar 38 and/or the turbine engine 13. As illustrated in FIG. 4, the stabilizing head 30 is coupled to the arm 28 (i.e., second arm portion 34) via the rigid connection 108 and the spreader arm 38 of the stabilizing head 30 is coupled to the turbine engine 13 via the rigid connection 92. As mentioned above, the stabilizing head 30 connects the arm 28 (i.e., second arm portion 34) to the main portion 76 of the spreader bar 38 at a position 130 along the length 80 of the main portion 76. As illustrated, the spreader bar 38 includes only the main portion 76 coupled to the turbine engine 13. The main portion 76 of the spreader bar 38 is connected to plates 96 and 132 via flanges 88 and 86, respectively. The spreader bar 38 is connected to the turbine engine 13 via plates 96 and 132 as described above in FIG. 3. In the embodiment illustrated in FIG. 4, the turbine engine 13 may include a gas turbine engine or a power turbine engine. In other embodiments, the turbine engine 13 may include a steam turbine, a turbine generator, or another module of a turbine system. Furthermore, the unit 13 may be a combustion engine, a transmission, or another bulky system of the watercraft 10.

Alternatively, as illustrated in FIG. 5, the spreader bar 38 may include the main portion 76 and the extension portion 78 connected to the turbine engine 13 as described in FIG. 3. The configuration of the spreader bar 38 in FIG. 5 may be employed due to a center of gravity 131 and/or a length 133 of the turbine engine 13. Similar to FIG. 4, the turbine engine 13 of FIG. 5 may include a gas turbine engine, a power turbine engine, a steam turbine engine, a turbine generator, or another turbine system. In certain embodiments, the main portion 76 and extension portion 78 may be selectively coupled to the turbine engine 13 to align the center of gravity 131 of the engine 13 with the connection position 130 between the spreader bar 38 (e.g., main portion 76) and the arm 28. In this manner, the spreader bar 38 provides a more uniform distribution of weight relative to the arm 28 and head 30.

In certain embodiments, the center of gravity may vary due to the assembly of multiple turbine components. As illustrated in FIG. 6, the gas turbine engine 13 includes both a gas turbine engine 134 and a power turbine engine 136. The gas turbine engine 13 is connected to the spreader bar 38 as described in FIG. 3. For example, the gas turbine engine 134 (e.g., approximately 9,000-10,000 lbs.) may weigh more than the power turbine engine 136 (e.g., approximately 4,500 lbs.). In certain embodiments, the gas turbine engine 134 may account for approximately 50 to 90 percent, 50 to 65 percent, 60 to 80 percent, or 75 to 90 percent of a total weight of the turbine engine 13. For example, the gas turbine engine 134 may account for approximately 50, 55, 60, 65, 70, 75, 80, 85, or 90 percent, or any percent therebetween, of the total weight of the turbine engine 13. In addition, a length 138 of the gas turbine engine 134 (e.g., 70 percent of the total length 133) may account for a greater percent of the total length 133 as compared to the power turbine engine 136 (e.g., length 140 of approximately 30 percent of the total length 133). In certain embodiments, the length 138 of the gas turbine engine 134 may account for approximately 50 to 90, 50 to 65 percent, 60 to 80 percent, or 75 to 90 percent of the total length 133 of the turbine engine 13. For example, the length 138 of the gas turbine engine 134 may account for approximately 50, 55, 60, 65, 70, 75, 80, 85, or 90 percent of the total length 133 of the turbine engine 13. The distribution of weight between the gas turbine engine 134 and the power turbine engine 136 as well as the lengths 138 and 140 of these engines 134 and 136 affect the center of gravity of the turbine engine 13 lifted by the turbine lift 12. The spreader bar 38 includes the extension portion 78 to accommodate for the center of gravity of the lifted turbine engine 13. Again, the spreader bar 38 may be specifically configured with suitable lengths of the main portion 76 and extension portion 78 to align the center of gravity 131 with the connection position 130 between the spreader bar 38 (e.g., main portion 76) and the arm 28. In certain embodiments, the main portion 76 and extension portion 78 may enable positioning of the connection 130 directly at the center of gravity 131 or within 0 to 20, 0 to 15, 0 to 10, or 0 to 5 percent of the total length 133. Thus, the main portion 76 and extension portion 78 may substantially balance the weight of the engine 13 relative the arm 28 and head 30. Taking into account the factors of the turbine engine 13 (e.g., length, components, center of gravity) enables the turbine lift 12 to completely control the movement of the turbine engine 13 relative to the stationary ground (e.g., deck 24 of the watercraft 10). In particular, the rigid connection 92 between the turbine lift 12 and the turbine engine 13 minimizes the movement between the lift 12 and engine 13 (e.g., during rough seas), thereby protecting the engine 13 and watercraft 10 from potential damage caused by unpredictable motion related to the sea.

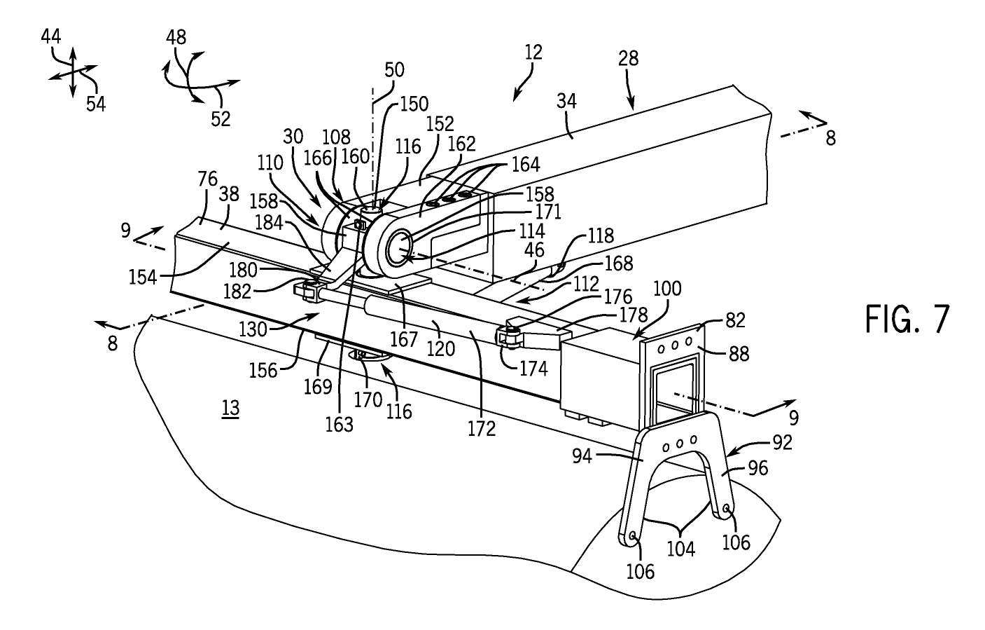

FIG. 7 is a close-up perspective view of an embodiment of the stabilizing head 30 of the turbine lift 12 of FIG. 3. FIG. 7 illustrates the stabilizing head 30 coupled to the arm 28 (i.e., second arm portion 34). The stabilizing head 30 is configured to connect with and stabilize the turbine engine 13 during the installation and/or removal of the turbine engine 13. The stabilizing head 30 includes the spreader bar 38 connected to the turbine engine 13. As illustrated, the spreader bar 38 includes the main portion 76 connected to the turbine engine 13 via rigid connection 92 as described above in FIG. 3. The stabilizing head 30 connects the arm 28 (i.e., second arm portion 34) to the main portion 76 of the spreader bar 38 at the position 130 along the length 80 of the main portion 76. The spreader bar 38 includes the rigid connection 108 configured to rigidly connect the spreader bar 38 to the arm 28 (i.e., second arm portion 34). For example, the stabilizing head 30 includes a king pin 150 that extends from a joining block 152 of the stabilizing head 30 through both a top side 154 and a bottom side 156 of the spreader bar 38. The king pin 150 is secured to the joining block 152 via a horizontal pin 158 that extends around a top portion 160 of the pin 150 via a threaded connection. As illustrated the pins 150 and 158 are crosswise (e.g., perpendicular) to one another. The king pin 150 and horizontal pin 158 are secured to the joining block 152 via securing plate 162. Securing plate 162 is attached to the joining block 152 via fasteners 164. The king pin 150 is prevented from rotating about axis 52 by an anti-rotation pin and block 163 that extends into the top portion 160 of the pin 150. The anti-rotation pin and block 163 is located above the horizontal pin 158 between the opposite bearings 166. The king pin 150 extends through reinforcement plates 167 and 169 that flank the top and bottom sides 154 and 156 of the spreader bar 38.

The stabilizing head 30 of the turbine lift 12 includes the joint assembly 110 and the drive assembly 112 coupled to the joint assembly 110 to enable complete control of the turbine engine 13 during lifting (e.g., installation and/or removal) in every degree of freedom between the turbine engine 13 and stationary ground. The joint assembly 110 enables movement of the turbine engine 13 about multiple axes of rotation 46 and 50. For example, the joint assembly 110 includes the first joint 114 with the first axis of rotation 46 (e.g., horizontal axis of rotation) to enable rotation of the joint assembly 110 as indicated by arrow 48. The first joint 114 includes the horizontal pin 158 and bearings 166 and 171. The first joint 114 in conjunction with the king pin 150 enables gravity to pull the turbine engine 13 connected to the spreader bar 38 straight down in vertical direction 44. The joint assembly 110 also includes the second joint 116 with the second axis of rotation 50 (e.g., vertical axis of rotation) to enable rotation of the joint assembly as indicated by arrow 52. The axes of rotation 46 and 50 are crosswise (e.g., perpendicular) to one another. The drive assembly 112 is configured to control rotation of the joint assembly 110 about the axes 46 and 50. For the example, the drive assembly 112 includes the first drive 118 (e.g., hydraulic or electrically driven cylinder 168) configured to control rotation of the first joint 114 about the first axis of rotation 46 (e.g., horizontal axis of rotation). For example, the cylinder 168 may be a telescopic assembly with a concentric arrangement of cylindrical members one inside another, such that one member can be extended and retracted relative to another member. The first drive 118 is connected to the second arm portion 34 and the spreader bar 38. The first drive 118 is connected to the spreader bar 38 via a connector 170 connected to the cylinder 168 (e.g., leveling cylinder). In particular, the connector 170 is connected to a bottom portion of the king pin 150. In addition to the first joint 114 in conjunction with the king pin 150 enabling gravity to pull the turbine engine 13 straight down in the vertical direction 44, the first drive 118 enables a controlled rotation of the joint assembly 110 about the first axis of rotation 46. This enables control of swing in movement 48 of the turbine engine 13 in both the horizontal direction 54 and the vertical direction 44 relative to the stationary ground.

The drive assembly 112 also includes the second drive 120 (e.g., hydraulic or electrically driven cylinder 172) configured to control rotation of the second joint 116 about the second axis of rotation 50 (e.g., vertical axis of rotation). For example, the cylinder 172 may be a telescopic assembly with a concentric arrangement of cylindrical members one inside another, such that one member can be extended and retracted relative to another member. The second drive 120 is connected to the spreader bar 38 and the king pin 150. The second drive 120 (e.g., rotational cylinder 172) is connected to the end 100 of the spreader bar 38 via a clevis 174 secured via pin 176 to a connector 178. The second drive 120 is connected to the king pin 150 via a clevis 180 secured via pin 182 to a rotation lever 184, which is connected to the horizontal pin 158. The joint assembly 110 and the drive assembly 112 enable the turbine lift 12 to completely control the movement of the turbine engine 13 relative to the stationary ground (e.g., deck 24 of the watercraft 10). In particular, the rigid connection 92 and 108 minimize the movement between the lift 12 and engine 13 (e.g., during rough seas) and provides a safer environment for moving (e.g., removing or installing) the engine 13), thereby protecting the engine 13 and watercraft 10 from potential damage caused by unpredictable motion related to the sea.

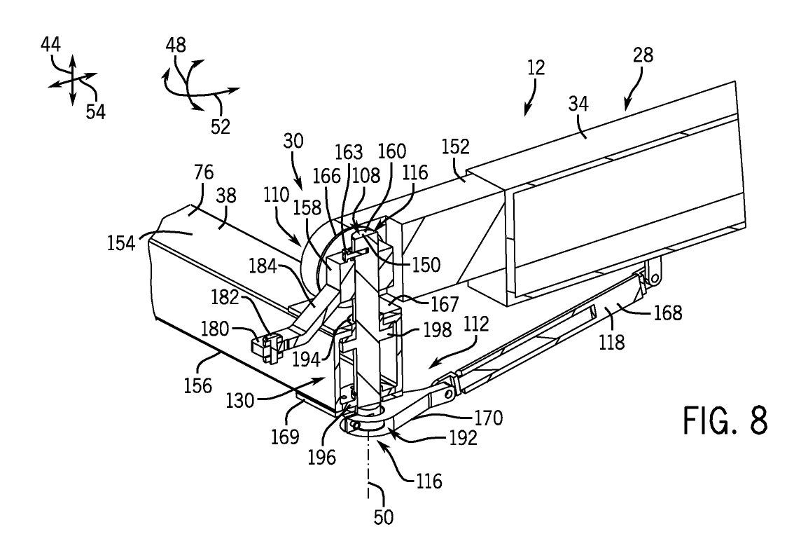

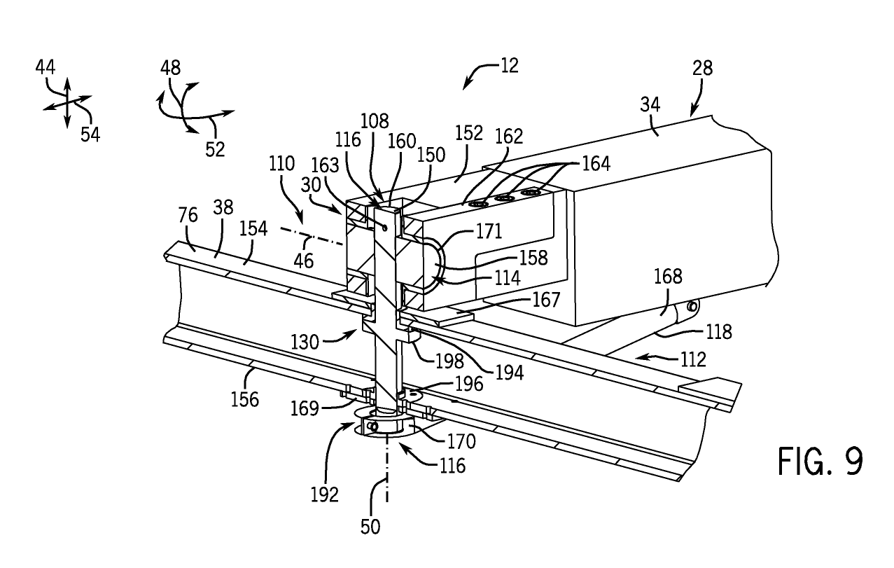

FIGS. 8 and 9 are partial cutaway perspective views of an embodiment of the stabilizing head 30 of FIG. 7, taken along lines 8-8 and 9-9 of FIG. 7, respectively. The stabilizing head 30 including the joint assembly 110 and the drive assembly 112 are as described in FIG. 7. FIGS. 8 and 9 further illustrate the structural and functional relationship between the components of the stabilizing head 30 that enable the stabilizing head 30 to stabilize the turbine engine 13 during the installation and/or removal of the turbine engine 13. As mentioned above, the spreader bar 38 includes the rigid connection 108 with the arm 28 (i.e., second arm portion 34) via the king pin 150. The king pin 150 is secured to the joining block 152 via the horizontal pin 158 that extends around the top portion 160 of the pin 150. The king pin 150 and horizontal pin 158 are secured to the joining block 152 via the securing plate 162. The horizontal pin 158 includes bearings 171 (e.g., annular bearings) to enable smooth rotation about the axis 46 to rotate the spreader bar 38 and, thus, the turbine engine 13 as described above. The first drive 118 is connected to the spreader bar 38 via the connector 170 connected to the cylinder 168 (e.g., leveling cylinder). In particular, the connector 170 is connected to a bottom portion 192 of the king pin 150. In addition to the first joint 114 in conjunction with the king pin 150 enabling gravity to pull the turbine engine 13 straight down in the vertical direction 44, the first drive 118 enables controlled rotation of the joint assembly 110 about the first axis of rotation 46. This enables control of swing in movement 48 of the turbine engine 13 in both the horizontal direction 54 and the vertical direction 44 relative to the stationary ground.

As illustrated, the king pin 150 extends from the joining block 152 of the stabilizing head 30 through the top and bottom sides 154 and 156 of the spreader bar 38. The king pin 150 extends through reinforcement plates 167 and 169 that flank the top and bottom sides 154 and 156 of the spreader bar 38. The king pin 150 is kept from rotating relative to the spreader bar 38 via the anti-rotation pin and block 163 extending partially into the pin 150. Within the spreader bar 38, the king pin 150 is associated with bearings 194 and 196 (e.g., annular bearings). Bearings 194 and 196 are disposed near the top and bottom sides 154 and 156, respectively. The bearings 194 and 196 are configured to enable rotation of the spreader bar 38 (e.g., main portion 76) and engine 13 about the pin 150 (e.g., axis 50) in response to a controlled force provided by the second drive 120. The bearings 194 and 196 also provide a tight interface between the pin 150 and the spreader bar 38 to reduce any undesirable pivoting away from the axis 50. In addition, the bearings 194 and/or 196 may be thrust bearings configured to absorb the axial thrust or weight of the turbine engine 13. The king pin 150 also includes a flange 198 disposed within the spreader bar 38 adjacent the top side 154 and bearing 194. The flange 198 is configured to support the weight of the turbine engine 13. These features of the stabilizing head 30 enable the turbine lift 12 to completely control the movement of the turbine engine 13 relative to the stationary ground (e.g., deck 24 of the watercraft 10). In particular, the rigid connection 108 minimizes the movement between the lift 12 and engine 13 (e.g., during rough seas), thereby protecting the engine 13 and watercraft 10 from potential damage caused by unpredictable motion related to the sea.

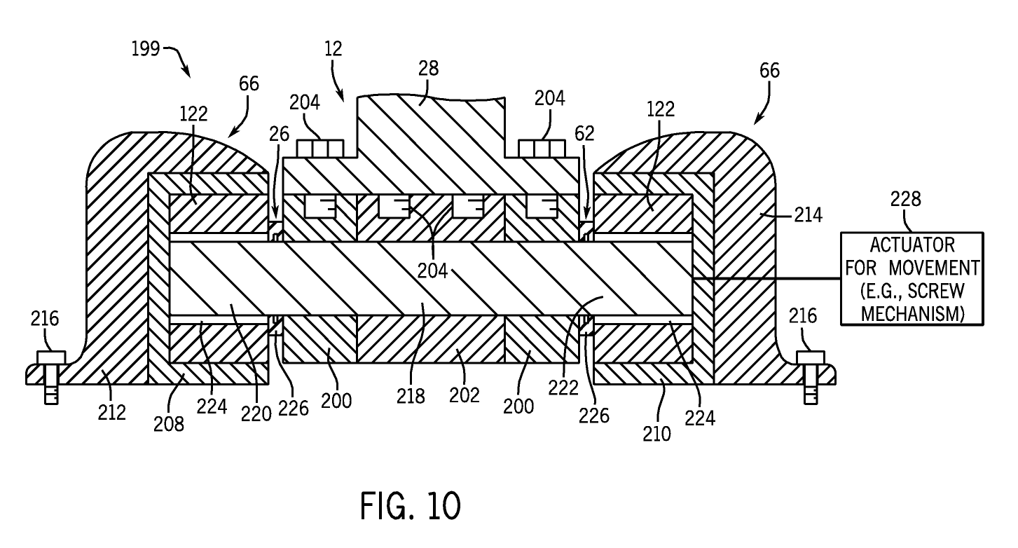

As mentioned above, the turbine lift 13 is configured to move between compartments 20 and 22 of turbine engines 13, for example, along the deck 24 of the water craft 10. In particular, the mounting base 26 enables movement of the turbine lift 12. FIG. 10 is a schematic side view of an embodiment of a movable base system 199 for moving the turbine lift of FIGS. 1 and 2. As illustrated, the arm 28 (i.e., first arm portion 32) is coupled to the mounting base 26. For example, the arm 28 is coupled to supports 200 that run parallel to the rail structures 66 and supports 202 that extend crosswise to and between the rail structures 66. The arm 28 is coupled to supports 200 and 202 via fasteners 204 (e.g., bolts). The mounting base 26 includes the sliding portion 62 configured to move the arm 28 along the deck 24 of the watercraft 10. In some embodiments, the sliding portion 62 is configured to enablement movement of the turbine lift 12 along the rail structure 66. The illustrated rail structure 66 includes channels 208 and 210 (e.g., U-shaped beams) supported by structural supports 212 and 214, respectively. The structural supports 212 and 214 are secured to the deck 24 via fasteners 216 (e.g., bolts). The structural supports 212 and 214 are configured to prevent the channels 208 and 210 and, thus, the turbine lift 12 from lifting from the deck 24 during the lifting of the turbine engine 13 and during the movement of the lift 12 with the engine 13 along the rail system 66. In the illustrated embodiment, the sliding portion 62 of the mounting base 26 includes at least two axles 218 that extend crosswise to and between the rail structures 66 through the supports 200 and 202. In certain embodiments, the sliding portion 62 may include more than two axles 218. For example, the sliding portion 62 may include 2 to 10 axles 218 or any other number of axles 218. The opposite ends 220 and 222 of each axle 218 include respective wheels 122 configured to move the turbine lift 12 along the respective channels 208 and 210. Bearings 224 disposed between the wheels 122 and the axles 218 enable smooth rotation of the wheels 122 about the axels 218. Spacers 226 separate the wheels 122 from the supports 200 to reduce friction between the wheels 122 and the supports 200. In certain embodiments, the spacers 226 may include bearings, low friction bushings, or a combination thereof.

The mounting base 26 includes an actuator 228 configured to drive movement of the sliding portion 62 along the rail structures 66. The actuator 228 is also configured to block undesired movement of the turbine lift 12 along the rail structures 66. In certain embodiments, the actuator 228 may include a screw mechanism (e.g., acme screw) to move the turbine lift 12 back and forth along the rail structures 66. In some embodiments, the actuator 228 may include a rack and pinion. In other embodiments, the actuator 228 may include a chain drive or belt drive. In further embodiments, the actuator 228 may include drive wheels in conjunction with a gear box having reduction gears. The above components of the mounting base 26 enable the turbine lift 12 to move the turbine engine 13 in a stable, controlled manner during installation and/or removal of the engine, particularly in marine applications aboard watercraft 10 during rough seas.

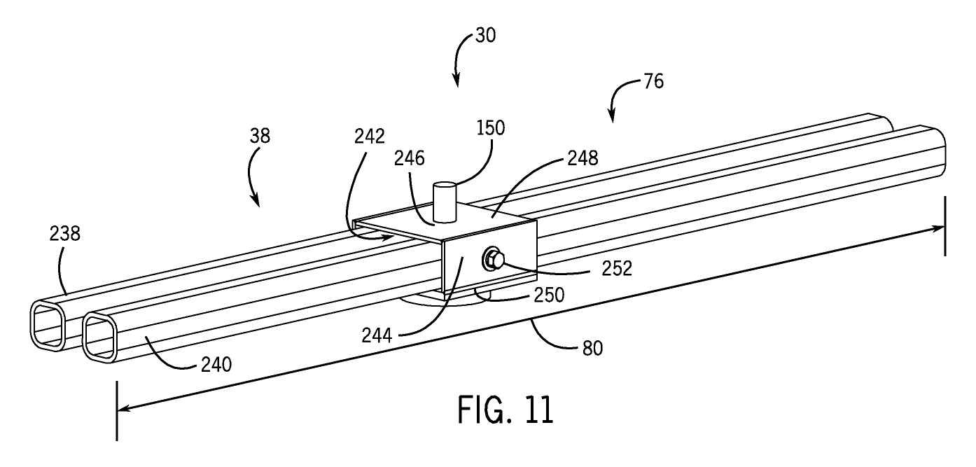

Alternative to the single bar or beam 79 forming the main portion 76 of the spreader bar 38, the spreader bar 38 may include multiple bars. FIG. 11 is a perspective view of an embodiment of the main portion 76 of the spreader bar 38. As illustrated, the main portion 76 of the spreader bar 38 includes two bar or beams 238 and 240 inserted through an opening 242 of an open-ended retainer or box 244 (e.g., steel box). The king pin 150 extends through an opening 246 of sides 248 and 250 of the box 244 in a direction crosswise (e.g., perpendicular) to the length 80 of the beams 238 and 240. The king pin 150 extends through the box 244 between the beams 238 and 240. Each beam 238 and 240 is secure to the box 244 via a fastener 252 (e.g., bolt) that extends through openings in the box 244 and beams 238 and 240 to abut against the king pin 150. Each beam 238 and 240 may include multiple opening or holes for the fastener 252 to enable the position of the box 244 along the length 80 of the beams 238 and 240 to be adjusted and, thus, the position of the lifting point for the turbine engine 13 to be adjusted. The beams 238 and 240 and box 244 may be connected to stabilizing head 30, joint assembly 100, and drive assembly 112 as described above. In addition, the beams 238 and 240 of the spreader bar 38 function together similar to single bar embodiments of the spreader bar 38.

Technical effects of the disclosed embodiments include providing lifting systems to lift turbine engines 13 employed in marine applications (e.g., aboard watercraft 10) especially during rough sea conditions. The turbine lift 12 includes the rigid connection 108 between the spreader bar 38 of the stabilizing head 30 and the arm 28. In addition, the turbine lift 12 includes the rigid connection 92 between the spreader bar 38 and the turbine engine 13. The rigid connections 92 and 108, as opposed to loose or flexible connections such as chains or straps, reduce the possibility of uncontrolled movements of the turbine engine 13. The turbine lift 12 also includes the joint assembly 110 and the drive assembly 112 to control the movement of the turbine engine 12 about multiple axes of rotation (e.g., vertical and horizontal axes). Together these features enable the turbine lift 12 to completely and stably control the movement of the turbine engine 13 relative to the stationary ground (e.g., deck 24 of the watercraft 10) during installation and/or removal of the engine 13, while minimizing undesired movement between the lift 12 and engine 13 (e.g., during rough sea conditions). Additional features include the ability to adjust the spreader bar 38 based on factors related to the turbine engine (e.g., length, center of gravity, configuration of engine 13). Further features include the mounting base 26 configured to move the arm 28 along the deck 24 of the watercraft 10 (e.g., along rail structures 66) and to rotate the arm 28 about an axis crosswise to the deck 24 of the watercraft 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a turbine lift, comprising:
a mounting base configured to mount to a non-stable structure;
an arm coupled to the mounting base; and
a stabilizing head coupled to the arm, wherein the stabilizing head is configured to connect with a turbine engine, and the stabilizing head is configured to stabilize the turbine engine while moving the turbine engine.

2. The system of claim 1, wherein the stabilizing head comprises a joint assembly comprising a first joint having a first axis of rotation.

3. The system of claim 2, wherein the joint assembly comprising a second joint having a second axis of rotation, and the first and second axes of rotation are crosswise relative to one another.

4. The system of claim 2, wherein the stabilizing head comprises a first drive configured to control rotation of the first joint about the first axis of rotation.

5. The system of claim 3, wherein the stabilizing head comprises a first drive configured to control rotation of the first joint about the first axis of rotation, and a second drive configured to control rotation of the second joint about the second axis of rotation.

6. The system of claim 1, wherein the arm comprises a first arm portion coupled to the mounting base and a second arm portion coupled to the first arm portion at a movable joint, and the second arm portion is coupled to the stabilizing head.

7. The system of claim 1, wherein the stabilizing head comprising a spreader bar configured to rigidly connect with the turbine engine.

8. The system of claim 7, wherein the spreader bar comprises a main portion and one or more extension portions, and the stabilizing head is configured to connect the arm to the main portion of the spreader bar.

9. The system of claim 1, wherein the mounting base comprises a sliding portion and a rotating portion, the sliding portion is configured to move the arm along a deck of a watercraft, and the rotating portion is configured to rotate the arm about an axis crosswise to the deck of the watercraft.

10. A system, comprising:
a turbine lift, comprising:
a mounting base;
an arm coupled to the mounting base; and
a stabilizing head coupled to the arm, wherein the stabilizing head is configured to connect with a turbine engine, the stabilizing head comprises a drive assembly coupled to a joint assembly, and the joint assembly comprises at least one axis of rotation.

11. The system of claim 10, comprising a watercraft having the turbine lift, wherein the mounting base is coupled to a deck of the watercraft.

12. The system of claim 10, wherein the joint assembly comprises first and second axes of rotation that are crosswise to one another.

13. The system of claim 10, wherein the drive assembly comprises a first drive configured to control rotation of the joint assembly about a horizontal axis of rotation, and the drive assembly comprises a second drive configured to control rotation of the joint assembly about a vertical axis of rotation.

14. The system of claim 10, wherein the stabilizing head comprising a spreader bar having a main portion and one or more extension portions, and the stabilizing head is configured to connect the arm to the main portion of the spreader bar.

15. The system of claim 10, wherein the mounting base comprises a sliding portion having a plurality of wheels disposed along a rail structure.

16. A system, comprising:
a turbine lift, comprising:
a mounting base;
an arm coupled to the mounting base; and
a stabilizing head comprising a spreader bar configured to support a turbine engine, wherein the spreader bar comprises a first rigid connection configured to rigidly connect the spreader bar to the turbine engine, or a second rigid connection configured to rigidly connect the spreader bar to the arm, or a combination thereof.

17. The system of claim 16, wherein the arm comprises first and second arm portions coupled together at a rotatable joint, the stabilizing head comprises a joint assembly having horizontal and vertical axes of rotation, the stabilizing head comprises a drive assembly configured to control rotation of the joint assembly about the horizontal and vertical axes of rotation, and the spreader bar comprises the first and second rigid connections.

18. The system of claim 17, comprising a watercraft having the turbine lift, wherein the mounting base comprises a sliding portion having a plurality of wheels disposed along a rail structure, and the mounting base is coupled to a deck of the watercraft.

19. A system, comprising:
a turbine lift, comprising:
a mounting base;
an arm coupled to the mounting base; and
a stabilizing head comprising a spreader bar configured to support a turbine engine, wherein the spreader bar comprises a main portion and one or more extension portions, and the stabilizing head is configured to connect the arm to the main portion of the spreader bar.

20. The system of claim 19, wherein the arm comprises first and second arm portions coupled together at a rotatable joint, the stabilizing head comprises a joint assembly having first and second axes of rotation that are crosswise to one another, and the stabilizing head comprises a drive assembly configured to control rotation of the joint assembly about the first and second axes of rotation.
